(19) United States
(12) Patent Application Publication
(10) Pub. No.: US 2018/0328411 A1
(43) Pub. Date: Nov. 15, 2018

(54) LUBRICATING OIL SUPPLY DEVICE

(71) Applicant: THK CO., LTD., Tokyo (JP)

(72) Inventors: Masahiko Yoshino, Tokyo (JP); Yuji Kubota, Tokyo (JP); Yohei Amemiya, Tokyo (JP)

(73) Assignee: THK CO., LTD., Tokyo (JP)

(21) Appl. No.: 15/775,932

(22) PCT Filed: Nov. 30, 2016
(86) PCT No.: PCT/JP2016/085529

§ 371 Date: May 14, 2018

(30) Foreign Application Priority Data
Dec. 11, 2015 (JP) 2015-241868

(51) Int. Cl. F16C 33/66; F16H 25/22; F16H 25/24

(52) U.S. Cl. CPC F16C 33/6681; F16H 25/2214; F16C 33/6659; F16C 33/664; F16H 25/2418

(57) ABSTRACT

The lubricating oil supply device including: a storage body, which has a large number of air gaps thereinside, and is configured to retain the lubricating oil in the air gaps; a casing, which includes an accommodating chamber for the storage body, has an opening facing the raceway shaft and opening the accommodating chamber, and is fixed to the slide member; and a coating body, which is arranged in the opening of the casing to be held in abutment against the raceway shaft, and receives the lubricating oil to be supplied from the storage body, wherein the storage body has a cutout portion corresponding to the opening of the casing, and wherein the coating body has an air gap ratio smaller than an air gap ratio of the storage body and is sandwiched in the cutout portion of the storage body to push outward the cutout portion.

### TECHNICAL FIELD

The present invention relates to a lubricating oil supply device, which is provided to a linear motion device involving relative movement of a raceway shaft and a slide member through intermediation of rolling elements such as balls and is configured to supply a lubricating oil to the raceway shaft.

### BACKGROUND ART

As a lubricating oil supply device to be used for a linear mot ion device of this type, there has been known a lubricating oil supply device disclosed in Patent Literature 1. The lubricating oil supply device disclosed in Patent Literature 1 is applied to, for example, a rolling-element screw device such as a ball screw device. The lubricating oil supply device is mounted to a nut member threadedly engaged with a screw shaft through intermediation of a large number of rolling elements, and is configured to supply a lubricating oil to a rolling-element raceway surface of the screw shaft in accordance with a relative motion of the nut member and the screw shaft.

The lubricating oil supply device includes a casing, a storage body, a coating body, and an oil-amount control body. The casing is loosely fitted to a periphery of the screw shaft, and is fixed to the nut member. The storage body is configured to absorb and retain the lubricating oil in the casing. The coating body is arranged in the casing, and is held in abutment against the rolling-element raceway surface of the screw shaft. The oil-amount control body is arranged between the storage body and the coating body, and is configured to supply the lubricating oil from the storage body to the coating body. The coating body is arranged so as to be in a non-contact state with respect to the storage body. The lubricating oil retained in the storage body moves to the coating body only through the oil-amount control body, and is applied from the coating body to the rolling-element raceway surface of the screw shaft.

The storage body, the coating body, and the oil-amount control body are formed of, for example, wool felt. The air gap ratio of the wool felt is largest in the storage body, and is smallest in the coating body. The oil-amount control body has an intermediate air gap ratio between the above-mentioned air gap ratios of the storage body and the coating body. Thus, when the lubricating oil is applied from the coating body to the rolling-element raceway surface of the screw shaft, the lubricating oil retained in the storage body moves to the oil-amount control body by a capillary phenomenon, and further moves from the oil-amount control body to the coating body. With this action, the lubricating oil retained in the storage body is applied by a small amount to the rolling-element raceway surface in accordance with a motion of the nut member.

### CITATION LIST

### Patent Literature

[PTL 1] JP 2001-26:3448 A

### DISCLOSURE OF THE INVENTION

### Problems to be Solved by the Invention

Such related-art lubricating oil supply device has the following problems. It is required that, for example, a partition wall be provided between the storage body and the coating body in the casing to separate the storage body and the coating body from each other in a non-contact state. An accommodating space for the storage body is reduced by the space required for such configuration, with the result that the retainable amount of the lubricating oil is reduced. Further, the oil-amount control body also functions to limit the amount of the lubricating oil flowing from the storage body to the coating body. A space for providing the oil-amount control body is required in the casing. Also in this regard, the accommodating space for the storage body is reduced, with the result that the retainable amount of the lubricating oil is reduced. Such problems are liable to be conspicuous particularly in a case in which the lubricating oil supply device is applied to a linear motion device having a small size.

### Means for Solving the Problems

The present invention has been made in view of such problems, and has an object to provide a lubricating oil supply device capable of securing a sufficient accommodating space for a storage body while achieving downsizing of a casing.

That is, according to one embodiment of the present invention, there is provided a lubricating oil supply device, which is to be mounted to a slide member engaged with a raceway shaft through intermediation of a rolling element, and is configured to supply a lubricating oil to a rolling-element raceway surface of the raceway shaft in accordance with a relative movement of the slide member and the raceway shaft, the lubricating oil supply device including: a storage body, which has a large number of air gaps thereinside, and is configured to retain the lubricating oil in the air gaps; a casing, which includes an accommodating chamber for the storage body, has an opening facing the raceway shaft and opening the accommodating chamber, and is fixed to the slide member; and a coating body, which is arranged in the opening of the casing to be held in abutment against the raceway shaft, and receives the lubricating oil to be supplied from the storage body in the accommodating chamber. Further, the storage body has a cutout portion corresponding to the opening of the casing, and the coating body has an air gap ratio smaller than an air gap ratio of the storage body and is sandwiched in the cutout portion of the storage body to push outward the cutout portion.

### Effects of the Invention

According to the present invention, the coating body has an air gap ratio smaller than that of the storage body. Thus, when the coating body is sandwiched in the cutout portion formed in the storage body, the coating body pushes outward the storage body and squeezes part of the storage body. Accordingly, the air gap ratio of the storage body is partially reduced, and hence the lubricating oil retained in the storage body becomes more likely to be attracted from the storage body to the coating body by the capillary phenomenon. Therefore, it is not required that the oil-amount control body having the intermediate air gap ratio be provided between the storage body and the coating body, thereby being capable of securing a sufficient accommodating space for the storage body while achieving downsizing of the casing.

### BRIEF DESCRIPTION OF THE DRAWINGS

FIG. 1 is a perspective view for illustrating a ball screw device to which a lubricating oil supply device according to the present invention is applicable.

FIG. 2 is a perspective view for illustrating a lubricating oil supply device according to a first embodiment of the present invention.

FIG. 3 is an exploded perspective view of the lubricating oil supply device illustrated in FIG. 2.

FIG. 4 is a perspective view for illustrating a lubricating oil supply device according to a second embodiment of the present invention.

FIG. 5 is a perspective view for illustrating a lubricating oil supply device according to a third embodiment of the present invention.

FIG. 6 is a perspective view for illustrating another example of a shape of a casing of the lubricating oil supply device according to the present invention.

### MODE FOR CARRYING OUT THE INVENTION

Now, detailed description is made of a lubricating oil supply device according to the present invention with reference to the accompanying drawings.

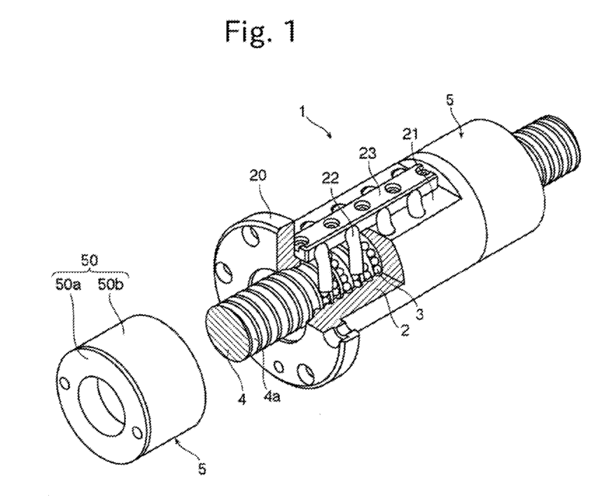

FIG. 1 is an illustration of a ball screw device 1 to which the lubricating oil supply device according to the present invention is applicable. In the ball screw device 1, a nut member (slide member) 2 is threadedly engaged with a screw shaft (raceway shaft) 4 through intermediation of a plurality of balls 3 being rolling elements. The balls 3 roll between the nut member 2 and the screw shaft 4, thereby enabling a relative spiral motion of the nut member 2 with respect to the screw shaft 4.

In an outer peripheral surface of the screw shaft 4, there is formed a spiral ball rolling groove 4a being a rolling-element raceway surface. In an inner peripheral surface of the nut member 2, there is formed a spiral load rolling groove being a load rolling-element rolling groove corresponding to the ball rolling groove 4a. The ball rolling groove 4a and the load rolling groove are opposed to each other, to thereby form a load path in which the balls 3 roll. The balls 3 roll so as to take a spiral path in a periphery of the screw shaft 4 while bearing a load acting between the nut member 2 and the screw shaft 4 in the load path.

The nut member 2 has a substantially cylindrical shape, and a flange portion 20 for coupling the nut member 2 to a mating component is formed at an end portion of the nut member 2 in an axial direction of the nut member 2. Further, a flat surface portion 21 is formed at a part of the outer peripheral surface of the nut member 2, and return pipes 22 each having a substantially U shape are mounted to the flat surface portion 21. In the return pipe 22, there is formed a no-load path having an inner diameter slightly larger than a diameter of the ball 3. The return pipes 22 are each mounted to the nut member 2 so as to extend over several turns of the spiral ball rolling groove 4a formed in the screw shaft 4, and are fixed to the nut member 2 by a pipe pressing member 23. When the return pipes 22 are mounted to the nut member 2 at predetermined positions thereof, one end and another end of the load path are coupled to each other by the no-load path. Thus, an endless circulation path for the balls 3 is completed.

For example, when the screw shaft 4 rotates with respect to the nut member 2, the balls 3 roll by the number of turns of the load path being present between the screw shaft 4 and the nut member 2, enter the no-load path formed in the return pipe 22 from the one end of the load path, roll in the no-load path, and thereafter return to the another end of the load path. When the rotation direction of the screw shaft 4 is reversed, the balls 3 circulate in an opposite direction in the endless circulation path. Further, the ball screw device 1 can be used also by rotating the nut member 2 without rotating the screw shaft 4.

A lubricating oil supply device 5 is mounted to each of both front and rear ends of the nut member 2. When the nut member 2 rotates relative to the screw shaft 4, the lubricating oil supply devices 5 apply a lubricating oil to the ball rolling groove 4a of the screw shaft 4.

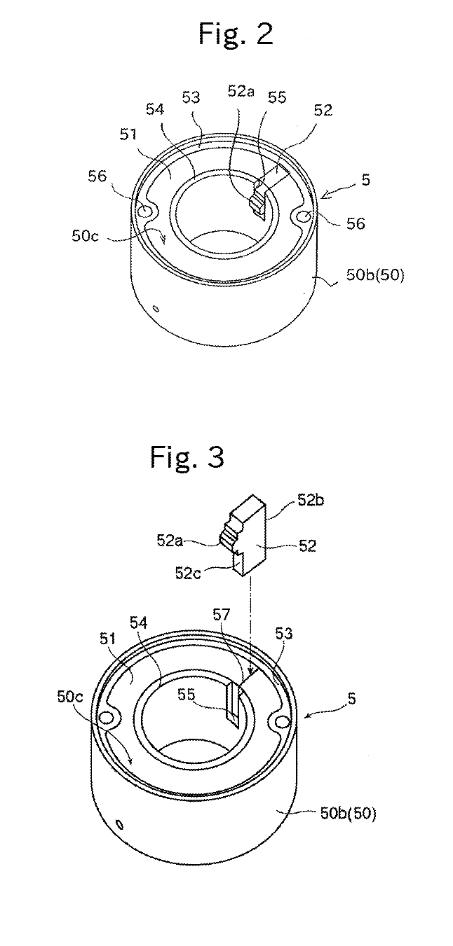

FIG. 2 is a perspective view for illustrating the lubricating oil supply device 5 according to a first embodiment of the present invention.

The lubricating oil supply device 5 includes a casing 50, a storage body 51, and a coating body 52. The casing 50 is fixed to the nut member 2. The storage body 51 is configured to retain the lubricating oil, and is accommodated in the casing 50. The coating body 52 is held in contact with the storage body 51 in the casing 50, and is configured to apply the lubricating oil supplied from the storage body 51 to the ball rolling groove 4a of the screw shaft 4.

The casing 50 is formed into a cylindrical shape having a through hole at a center for receiving the screw shaft 4 inserted therethrough. As illustrated in FIG. 1, the casing 50 includes a casing main body 50b and a lid member 50a. FIG. 2 is an illustration of a state in which the lid member 50a is removed from the casing main body 50b, for illustration of an internal structure of the lubricating oil supply device 5. The casing main body 50b includes an outer peripheral wall 53 and an inner peripheral wall 54. In the casing main body 50b, there is formed an accommodating chamber 50c for the storage body 51 and the coating body 52 between the outer peripheral wall 53 and the inner peripheral wall 54. The casing 50 is fixed to the nut member 2 by fixing bolts. The casing main body 50b has mounting holes 56 for allowing the fixing bolts to pass therethrough.

All oil-impregnated body which retains the lubricating oil impregnated therein is used as the storage body 51, and the oil-impregnated body is formed into a cylindrical shape suitably fitted to the accommodating chamber 50c between the outer peripheral wall 53 and the inner peripheral wall 54. As the oil-impregnated body forming the storage body, a fiber-interlaced body such as felt having a large air gap ratio is suitable so that a large amount of lubricating oil can be stored therein. In the first embodiment, there is used felt with an air gap ratio of 80% in which rayon and wool are mixed at a given ratio.

Meanwhile, the coating body is formed into a plate shape, and is arranged in the accommodating chamber 50c so as to divide the storage body. The casing main body 50b has an opening 55 which is formed by cutting out part of the inner peripheral wall 54, and the coating body is arranged in the accommodating chamber 50c so as to face the opening 55. The coating body 52 has a coating projecting piece 52a. The coating projecting piece 52a projects from the inner peripheral surface of the casing 50 through the opening 55, and is brought into abutment against the ball rolling groove 4a of the screw shaft 4. As the oil-impregnated body forming the coating body 52, a fiber-interlaced body such as felt having a small air gap ratio is suitable. In the first embodiment, wool felt having an air gap ratio of 50% is used. Through use of, for example, felt having a small air gap ratio, the lubricating oil required for coating can be retained by the coating body 52, and sufficient strength for tolerating sliding with the ball rolling groove 4a can be given to the coating body 52.

FIG. 3 is an exploded perspective view for illustrating a state in which the coating body 52 is taken out from the accommodating chamber 50c of the casing main body 50b. The storage body 51 is formed into a cylindrical shape suitably fitted to the accommodating chamber 50c, but also has a cutout portion 57 in conformity with the opening 55 of the casing main body 50b. The cutout portion 57 extends across the storage body 51 in a radial direction, and divides the storage body 51 in a circumferential direction. The coating body 52 is arranged in the accommodating chamber 50c of the casing main body 50b while pushing outward the cutout portion 57 of the storage body 51.

That is, the coating body 52 is arranged in the accommodating chamber 50c while pushing outward both end surfaces of the storage body 51 opposed to each other at the cutout portion 57. With this arrangement, the coating body 52 is pressed by the storage body 51 from both sides, and is held at a position of facing the opening 55 of the casing main body 50b. The coating body 52 is arranged in the accommodating chamber 50c so that the outer surface 52b is held in contact with the outer peripheral surface 53 of the casing main body 50b and that the inner surface 52c is held in contact with the inner peripheral wall 54 of the casing main body 50b. Only the coating projecting piece 52a projecting from the inner surface 52c is arranged in the opening 55 and held in abutment against the ball rolling groove 4a of the screw shaft 4. Therefore, a posture of the coating body 52 is held with the outer peripheral wall 53 of the casing main body 50b as a reference, thereby being capable of stably holding the coating projecting piece 52a in contact with the ball rolling groove 4a.

Further, a thickness of the coating body 52 between the outer surface 52b and the inner surface 52c may be set so as to be larger than a width of the accommodating chamber 50c of the casing main body 50b in a radial direction. In this case, the coating body 52 is compressed between the outer peripheral wall 53 and the inner peripheral wall 54 of the casing main body 50b, and the coating projecting piece 52a is brought into a state of being urged toward the screw shaft 4 in the opening 55 of the casing main body 50b. Thus, the coating projecting piece 52a and the ball rolling groove 4a of the screw shaft 4 are more reliably brought into abutment against each other. Therefore, for example, even when a diameter of the screw shaft 4 is small, and a distal end of the coating projecting piece 52a is thin, the lubricating oil can be reliably applied to the ball rolling groove 4a of the screw shaft 4.

The coating body 52 has an air gap ratio smaller than that of the storage body 51, and is less liable to be squeezed than the storage body 51. Thus, when the coating body 52 is sandwiched between both the end surfaces of the storage body 51, the storage body 51 is compressed by the amount of thickness of the coating body 52. Thus, the storage body 51 and the coating body 52 are brought into tight press-contact with each other without a gap. Further, the storage body 51 is not evenly compressed in its entirety, but only part in the vicinity of the coating body 52 is compressed. Thus, at this part, the air gap ratio tends to become smaller on a side closer to the coating body 52.

In the lubricating oil supply device 5 having such a configuration, the storage body 51 and the coating body 52 are held in press-contact with each other, and the air gap ratio of the coating body 52 is smaller than that of the storage body 51. Thus, the lubricating oil retained in the storage body 51 moves to the coating body 52 by the capillary phenomenon, and then is applied from the coating body 52 to the ball rolling groove 4a of the screw shaft 4. When the lubricating oil impregnated in the coating body 52 is consumed through coating to the ball rolling groove 4a, the lubricating oil retained in the storage body 51 moves to the coating body 52, and the lubricating oil retained in the storage body 51 is gradually consumed.

At this time, the air gap ratio is smaller on a side closer to the coating body 52 in the storage body 51. Thus, the capillary phenomenon is more likely to act on the lubricating oil retained in the storage body 51 on a side closer to the coating body 52. Therefore, even when there is a large difference in air gap ratio between the storage body 51 and the coating body 52 before assembly to the casing main body 50b, the lubricating oil can smoothly move from the storage body 51 to the coating body 52 at boundary surfaces between the storage body 51 and the coating body 52. Further, also in the storage body 51, the lubricating oil is more likely to flow toward the coating body 52.

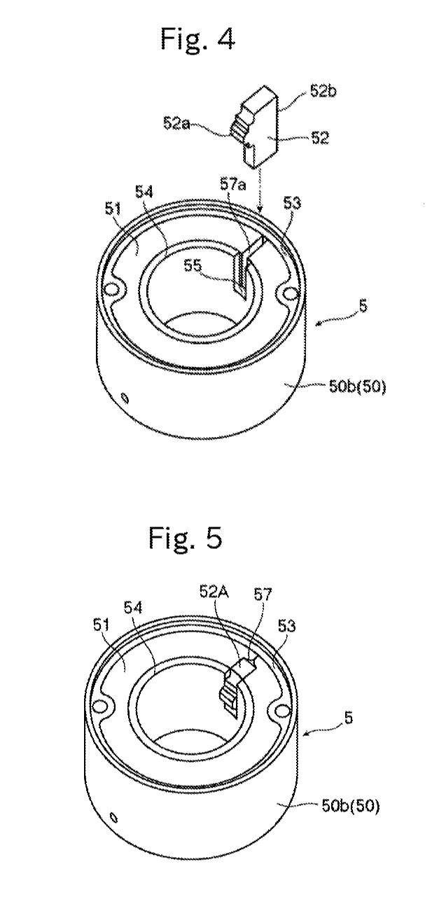

FIG. 4 is an illustration of the lubricating oil supply device 5 according to a second embodiment of the present invention.

The storage body 51 illustrated in FIG. 4 has a slit-like cutout portion 57a corresponding to the opening 55 of the casing main body 50b, and the coating body 52 is press-fitted to the cutout portion 57a. A slit width of the cutout portion 57a in the circumferential direction of the storage body 51 is set so as to be smaller than a thickness of the coating body 52. With this configuration, when the coating body 52 is press-fitted to the cutout portion 57a, the cutout portion 57a is pushed outward, and, similarly to the above-mentioned first embodiment, the coating body 52 is pressed by the storage body 51 from both sides, and is held at the position of facing the opening 55 of the casing main body 50b. In FIG. 4, components which are the same as those of the first embodiment are denoted by the same reference symbols as those of the first embodiment, and detailed description thereof is omitted.

Also in the lubricating oil supply device according to the second embodiment, the lubricating oil can smoothly move from the storage body 51 having a large air gap ratio to the coating body 52 having a small air gap ratio. Further, the lubricating oil retained in the storage body 51 becomes more likely to flow toward the coating body 52 in the storage body 51.

FIG. 5 is an illustration of the lubricating oil supply device 5 according to a third embodiment of the present invention.

In the third embodiment, the storage body 51 accommodated in the casing main body 50b has the cutout portion 57 which is the same as that of the first embodiment, and the cutout portion 57 extends across the storage body 51 in the radial direction. Meanwhile, a coating body 52A is press-fitted to the cutout portion 57 similarly to the first embodiment, but is not held in contact with the outer peripheral wall 53 of the casing main body 50b. That is, the coating body 52A is formed so as to be smaller than a width of the accommodating chamber 50c, which is formed in the casing main body 50b, in the radial direction, and partially pushes outward the cutout portion 57 formed in the storage body 51 to be held in the opening 55 of the casing main body 50b. In FIG. 5, components which are the same as those of the first embodiment are denoted by the same reference symbols as those of the first embodiment, and detailed description thereof is omitted.

In the lubricating oil supply device according to the third embodiment, the coating body 52A pushes outward only part of the cutout portion 57 of the storage body 51. Thus, the storage body 51 not only allows the coating body 52A to be sandwiched from both sides but also urges the coating body 52A toward the opening 55 of the casing main body 50b. With this action, the coating projecting piece of the coating body 52A is pressed against the ball rolling groove 4a of the screw shaft 4, thereby being capable of reliably applying the lubricating oil to the ball rolling groove 4a.

In such a lubricating oil supply device according to the present invention, it is not required that the oil-amount control body be interposed between the storage body and the coating body. Thus, a sufficient accommodating space for the storage body can be secured while achieving downsizing of the casing. Further, as mentioned above, the lubricating oil retained in the storage body becomes more likely to flow to the coating body, thereby being capable of providing a lubricating oil supply device having a small size and a long lifetime.

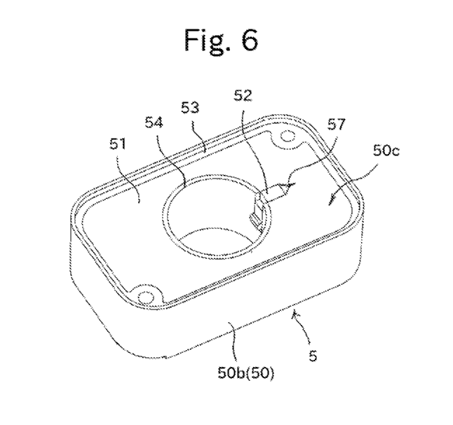

In the above mentioned embodiments, description is made only of the casing 50 having a cylindrical shape. However, for example, as illustrated in FIG. 6, the shape of the casing 50 may suitably be changed depending on the shape of a member to which the lubricating oil supply device is mounted.

Further, the linear motion device to which the lubricating oil supply device according to the present invention is applied is not limited to the ball screw device illustrated in FIG. 1. The lubricating oil supply device according to the present invention may be applied to a linear motion device in which a moving block being a slide member freely reciprocates along a raceway rail being the raceway shaft provided to a fixed portion. In this case, the lubricating oil supply device according to the present invention is mounted to the moving block, and the lubricating oil is applied with the coating body to the rolling-element raceway surface formed on the raceway rail. Further, the rolling elements are not limited to the balls, and may be rollers.

1-3. (canceled)

4. A lubricating oil supply device, which is mounted to a slide member engaged with a raceway shaft through intermediation of a rolling element, and is configured to supply a lubricating oil to a rolling surface of the rolling element of the raceway shaft in accordance with a relative movement of the slide member and the raceway shaft, the lubricating oil supply device comprising:
a storage body, which has a large number of air gaps thereinside, and is configured to retain the lubricating oil in the air gaps;
a casing, which has an inner peripheral wall in the face of the raceway shaft, has an outer peripheral wall having an accommodating chamber for the storage body with the inner peripheral wall, is fixed to the slide member, and has an opening for opening the accommodating chamber in the face of the raceway shaft formed in the inner peripheral wall; and
an application body, which is arranged in the accommodating chamber of the casing while facing the opening of the casing, has an air gap ratio lower than an air gap ratio of the storage body, and is held in abutment against a rolling surface of the rolling element of the raceway shaft through the opening, and to which the lubricating oil is to be supplied from the storage body,
wherein the storage body has formed therein a cutout portion, which crosses the storage body in a radial direction of the raceway shaft so as to be matched with the opening of the casing, and
wherein the application body is formed into a plate-like shape to be sandwiched by the cutout portion of the storage body, and is arranged in the accommodating chamber so as to push into the cutout portion.

5. The lubricating oil supply device according to claim 4, wherein the application body is sandwiched by the storage body, and is compressed between the inner peripheral wall and the outer peripheral wall of the casing.

6. The lubricating oil supply device according to claim 4, wherein the application body pushes into only a part of fee cutout portion of the storage body to be sandwiched by the storage body, and is urged by the storage body toward the inner peripheral wall of the casing.
